(19) United States
(12) Patent Application Publication
(10) Pub. No.: US 2022/0234698 A1
(43) Pub. Date: Jul. 28, 2022

(54) SYSTEMS AND METHODS ASSOCIATED WITH HYBRID FLOATING OFFSHORE WIND TURBINE (FOWT) PLATFORM AND SYNTACTIC BUOYANCY MATERIAL USED FOR THE PERIMETER COLUMNS

(71) Applicant: Offshore Dynamics, Inc., Houston, TX (US)

(72) Inventor: Shan Shi, Houston, TX (US)

(21) Appl. No.: 17/582,720

(22) Filed: Jan. 24, 2022

Related U.S. Application Data
(60) Provisional application No. 63/141,772, filed on Jan. 26, 2021.

(51) Int. Cl. B63B 39/02; B63B 35/44; B63B 5/24; B63B 21/20; F03D 13/25

(52) U.S. Cl. CPC B63B 39/02; B63B 35/44; B63B 5/24; B63B 21/20; F05B 2240/93; B63B 2035/446; B63B 2005/245; F05B 2240/95; F03D 13/25

(57) ABSTRACT

A hybrid floating offshore wind turbine energy conversion system using light weight solid syntactic buoyancy material columns for offshore application. Each wind turbine includes a deep draft Spar hull combined with several semi-submersible syntactic columns for extra buoyancy and stabilization.

### BACKGROUND INFORMATION

### Field of the Disclosure

Examples of the present disclosure relate to a hybrid floating offshore wind turbine energy conversion system using light weight, solid, syntactic buoyancy material columns for offshore applications. In embodiments, each wind turbine may include a deep draft spar hull and several semi-submersible syntactic columns for extra buoyancy and stabilization.

### Background

A floating wind turbine is an offshore wind turbine mounted on a floating structure. The floating structure allows the turbine to generate electricity in water depths where fixed-foundation turbines are not feasible. Floating wind farms have the potential to significantly increase the sea area available for offshore wind farms. Locating wind farms further offshore can also better utilize land and water, provide better accommodation for fishing and shipping lanes, and reach stronger and more consistent winds.

Conventional Floating Offshore Wind Turbines (FOWT) technology has achieved an average LCOE (Levelized Cost of Energy) of approximately $0.15-0.18/kWh, which higher in comparison to the current $0.03-0.05/kWh for land-based wind turbine technologies. High capital expenditures (CAPEX) are the key driver of the LCOE of a FOWT.

A significant portion of these CAPEX for FOWT is the cost of the steel and materials that existing floating platforms incorporate. Floating platforms are designed to be large and heavy in an effort to: (a) imitate the onshore wind turbine dynamics, (b) keep the system as stable as possible, and (c) maximize system survivability during events such as large sea storms. Studies show that the cost of steel for the existing platforms accounts for between 50% and 70% of the overall CAPEX for the existing FOWT designs.

Accordingly, needs exist for deep draft spar hulls with semi-submersible syntactic columns for extra buoyancy and stabilization that are configured to maximize a specific rotor area per unit of total mass (m2/kg), while maintaining, or ideally increasing, the turbine generation efficiency and reduce the CAPEX.

### SUMMARY

Embodiments disclosed herein describe main floating platform columns for FOWT that utilize light weight and low-cost syntactic buoyancy materials. The syntactic buoyancy materials combining the benefits of buoyant Spars and Semi-submersible platforms into one hybrid platform and limiting the negatives of each type of the platforms. Use of the new syntactic material significantly reduced the total displacement of the FOWT and reduce the higher prices associated with steel usage for the same and even better performance of the floating system under the design offshore environment.

Despite of invention of the new syntactic material, use of the syntactic foam for offshore platform semi-submersible columns and pontoons as functional members is new to the offshore industry.

Embodiments may be formed of a buoyant material that has around 10-20% the density of water. This may enable the hybrid floating offshore platforms to support wind turbines more effectively. For example, the syntactic materials may include foam or concrete with embedded plastic or composite objects filled with air or light weight material. Columns made of the syntactic materials may be used to provide additional buoyancy and restoring force/moment for the Spar hull, wherein the embedded plastic or composite objects filled with air or light weight material may drastically reduce the overall density of the columns of the FOWT.

Embodiments may utilize syntactic foam for the columns to provide buoyancy and restoring force/moment for the hybrid FOWT. Embodiments may reduce the total system buoyancy/mass for the same or better hydrostatic and hydrodynamic performance. The syntactic foam columns can be designed as round or rectangular section with or without variable section areas. They are directly connected to the center Spar hull through pontoons and bracings. The number of syntactic columns can be designed as 3 and more, the syntactic columns diameter and spacing between adjacent columns can be much less than the conventional semi-submersible platforms for the same capacity. This may also reduce the sea load of the platform.

In embodiments, if a dominate wind direction is determined, the column locations and sizing can be individually positioned and configured and designed to overcome the overturning moment caused by the wind turbine.

In embodiments, configurations connecting the syntactic buoyancy foams to its steel structural core to form floating platform columns are novel, wherein no damage flood control needs to be considered in the design for these types of columns due to the use of solid syntactic material. The use of syntactic columns significantly reduces the required draft of the Spar hull to provided buoyancy and lower the overall center of gravity. The platform is naturally floating and stable since its center of gravity is much lower than its center of buoyancy. Larger restoring force and moment can be provided to overcome the overturning moment produced by the large wind turbine.

In embodiments, the syntactic buoyancy material forming the columns may include a large number and size of light weight spheres, tubes, cubes, or cellular structures, which may have hollow internal chambers. These structures may be made of plastic, composite, foam, or voids, which are molded together using epoxy or cementing materials. The columns may be formed of a lightweight solid material filled buoyancy material that is designed to withhold hydrostatic pressure and wave load. Each column may be assembled with multiple molded pieces to provide the designed geometry and buoyancy.

The configuration of integrate Spar hull with syntactic semi-submersible column/pontoon structures could lower the system's center of gravity and reduce inertia radius of gyration.

In embodiments, the semi-submersible type syntactic columns' steel core may only serve as a structural connectivity member, not as a main buoyancy module. The steel cores may be stabilized with bracings to transfer the buoyancy force provided by the syntactic modules to support and stabilize the wind turbine tower. Embodiments may include a center Spar hull configured with two or more telescoping sections. The inner section of the telescoping sections may be lowered to extend and elongate the draft of the Spar and carry the liquid or solid ballast to lower the platform's center of gravity. The lower ballast section can be retracted during construction, installation, and decommissioning, which could benefit system integration and transportation. The Spar hull may be a double hull structure for flood damage control and to support the lower ballasted section. Embodiments may include a heave plate or a heave ballast tank positioned at the bottom of the Spar hull. This heave plate or tank may provide additional vertical hydrodynamic damping and/or ballast. Embodiments may also include horizontal, lateral, or angled beams extending between adjacent columns below the water surface or at the bottom of the columns. The horizontal beams may add bracing to the columns and transfer of loads. Above the water surface, adjacent columns may be interfaced together via lateral beams. In embodiments, a diameter of the Spar hull can be as small as the turbine tower diameter.

Further embodiments may include mooring lines. The mooring lines can be connected to the Spar hull to reduce the mooring line dynamics and the load on the columns. The mooring line can be chain braced to the adjacent pontoons or columns to reduce yaw motion of the platform and to help the clearance between mooring lines and the platform. Additional syntactic buoyancy sponson modules can be attached to the hull to provide extra buoyancy and stability during transit and maintenance.

These, and other, aspects of the invention will be better appreciated and understood when considered in conjunction with the following description and the accompanying drawings. The following description, while indicating various embodiments of the invention and numerous specific details thereof, is given by way of illustration and not of limitation. Many substitutions, modifications, additions or rearrangements may be made within the scope of the invention, and the invention includes all such substitutions, modifications, additions or rearrangements.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 depicts a perimeter column of a hybrid FOWT platform, according to an embodiment.

FIGS. 2-5 depict various views of different designs of hybrid FOWT platforms, according to embodiments.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help improve understanding of various embodiments of the present disclosure. Also, common but well-understood elements that are useful or necessary in a commercially feasible embodiment are often not depicted in order to facilitate a less obstructed view of these various embodiments of the present disclosure.

### DETAILED DESCRIPTION

In the following description, numerous specific details are set forth in order to provide a thorough understanding of the present invention. It will be apparent, however, to one having ordinary skill in the art that the specific detail need not be employed to practice the present invention. In other instances, well-known materials or methods have not been described in detail in order to avoid obscuring the present invention.

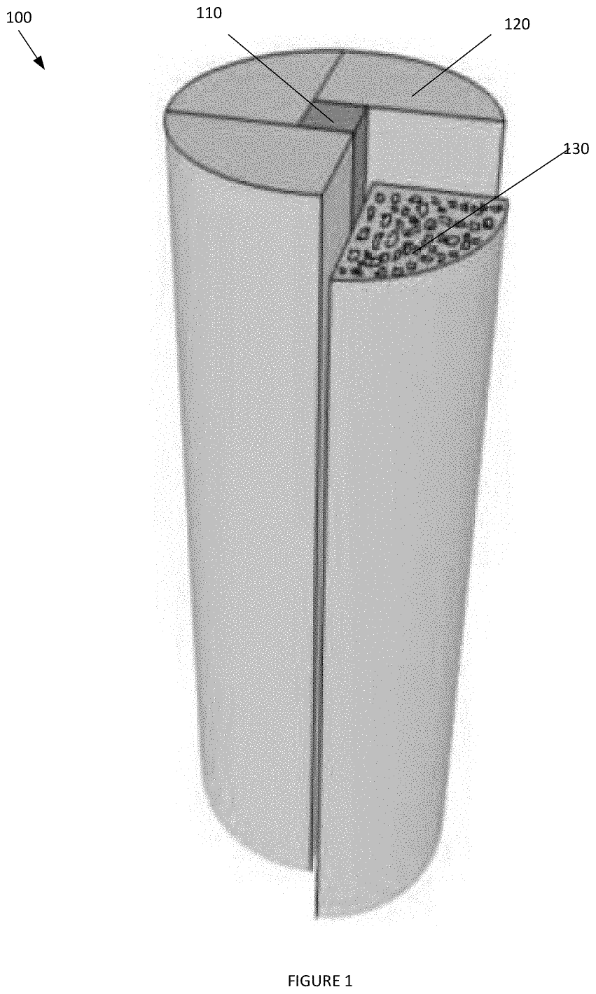

FIG. 1 depicts a perimeter column 100 of a hybrid FOWT platform, according to an embodiment. Perimeter column 100 may have a density of 10-20% of water. Due to the minimal density of perimeter column 100, perimeter column 100 may be more buoyant, cost less, and increase hydrostatic and hydrodynamic performance of wind turbines.

Column 100 may include a steel structural core 110 and syntactic material 120 with embedded buoyancy material 130.

Steel structural core 110 may be a steel structural member, which may be encompassed by syntactic material 120.

Syntactic material 120 may be formed in a plurality of parts that are coupled together and to steel structural core 110. Syntactic material 120 may be a foam that can create any shaped column 100, such as a rectangular, cylindrical, etc. Syntactic material 120 may have embedded buoyancy material 130. Buoyancy material 130 may include a large number of objects of various sizes and shapes, such as light weight spheres, tubes, cubes, or cellular structures. These objects may be formed of plastic, composite, foam, or voids, which are molded together using epoxy or cementing materials. In embodiments, the objects may have hollow internal chambers that may reduce the density of column 100.

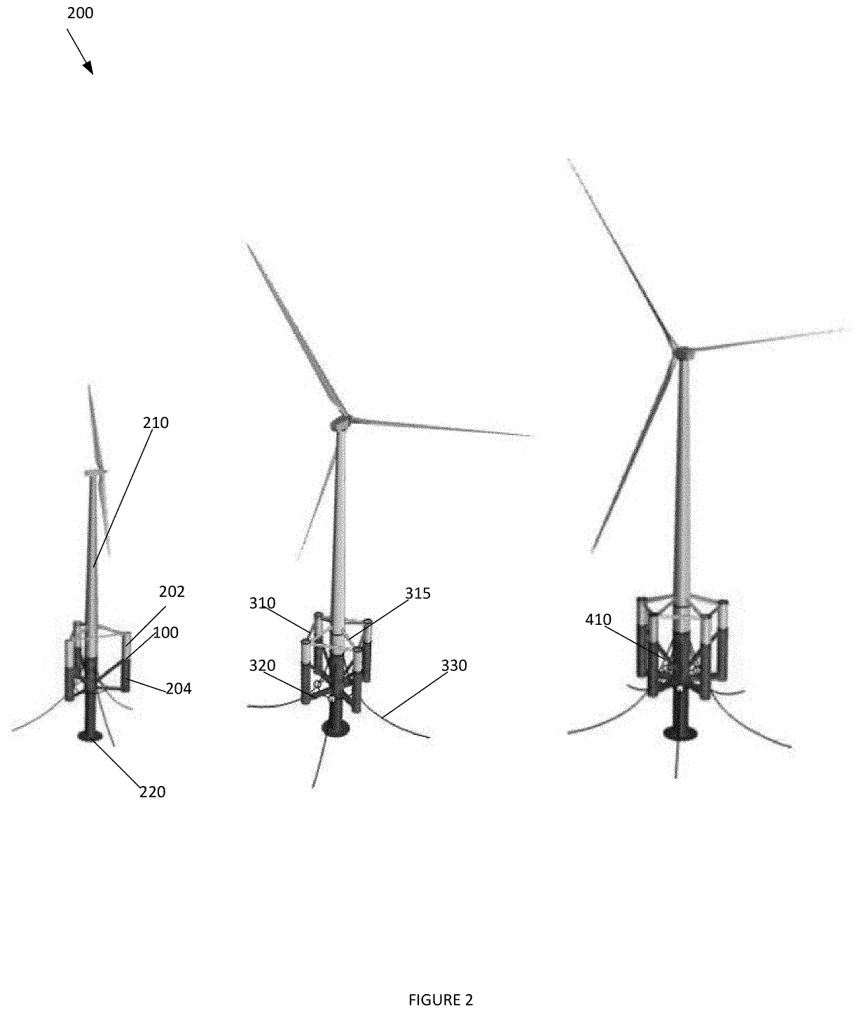

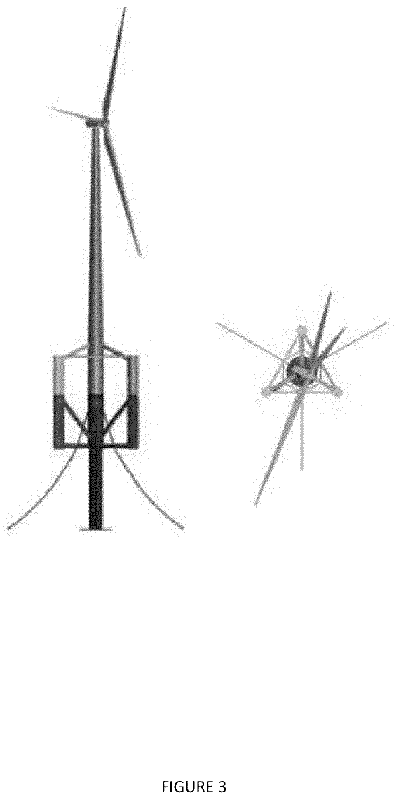

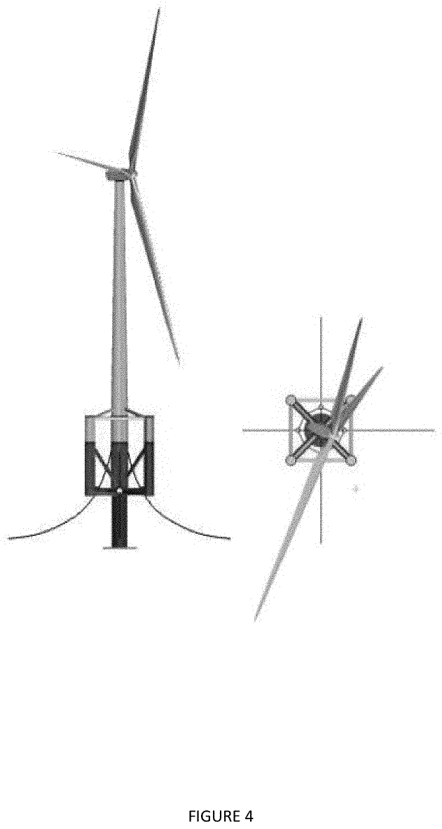

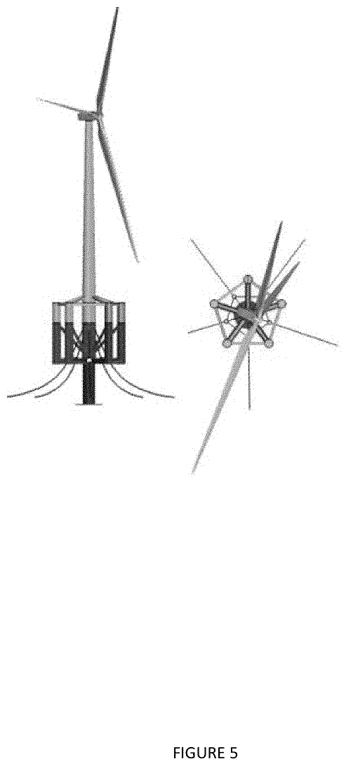

FIGS. 2-5 depict various views of different designs of hybrid FOWT platforms 200, according to embodiments. Each platform 200 may include a plurality of columns 100, which may have an upper portions 202 positioned above a water surface and a lower portion 204 positioned below a water surface. The number of columns 100 and the angularity and offset of each of the columns 100 in relation to each other may be based on design characteristics of platform 200, wherein the design characteristics may include the sizing of wind turbine 210, environmental features, number of moorings 330, etc.

Below platform 200 on the bottom of the spar hull may be a heave plate or tank 220. Heave plate or tank 220 may be configured to provide additional vertical hydrodynamic dampening and/or ballast.

The upper surfaces of each of the columns 100 may be coupled to the Spar hull via beams 315, and the adjacent columns 100 via beams 310. This may provide additional stability of load transference across platform 200.

The lower surfaces of each of the columns 100 may include a beam or pontoon 320 coupled to the Spar hull. Furthermore, each of the columns may have an angled beam 410 coupled to the spar hull. A first end of each of the beams 410 may be positioned at a design location of the column for stress consideration and extend at an angle towards the Spar hull.

Mooring lines 330 can be connected to the Spar hull to reduce the mooring line dynamics and the load on the columns 100. Each of the mooring lines 330 can be chain braced to the adjacent pontoons or columns to reduce yaw motion of the platform 200 and to help the clearance between mooring lines 330 and the platform 200.

Table 1 depicted below shows general design characteristics of a hybrid FOWT platform 200.

| | | | | | |
|---|---|---|---|---|---|
| Turbine power rating (MW) | 2 | 5 | 8 | 10 | 15 |
| Rotor diameter typical (m) | 72 | 112 | 130 | 178 | 240 |
| Gap/deck clearance [calculated] | 34 | 29 | 25 | 21 | 15 |
| Hub Height (m) from deck level | 70 | 85 | 90 | 110 | 135 |
| Tower base (Spar) diameter (m) | 4 | 6 | 7 | 8 | 10 |
| Column foam diameter (m) | 3 | 4 | 4 | 5 | 6 |
| Number of Foam Columns | 3 | 3 | 3 | 3 or 4 | 4 or 5 |
| Spar draft (m) - estimated | 30-40 | 30-50 | 35-50 | 40-50 | 50-60 |
| | [30] | [40] | [45] | [50] | [60] |
| Column draft (m) | 15 | 20 | 20 | 25 | 30 |
| Free board (m) | 9 | 15 | 15 | 15 | 15 |
| Spar center to Column center (m) | 14 | 16 | 18 | 20 | 25 |
| Number of chain mooring | 3 | 3 | 3 | 3 or 4 | 4 or 5 |

Reference throughout this specification to “one embodiment”, “an embodiment”, “one example” or “an example” means that a particular feature, structure or characteristic described in connection with the embodiment or example is included in at least one embodiment of the present invention. Thus, appearances of the phrases “in one embodiment”, “in an embodiment”, “one example” or “an example” in various places throughout this specification are not necessarily all referring to the same embodiment or example. Furthermore, the particular features, structures or characteristics may be combined in any suitable combinations and/or sub-combinations in one or more embodiments or examples. In addition, it is appreciated that the figures provided herewith are for explanation purposes to persons ordinarily skilled in the art and that the drawings are not necessarily drawn to scale.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

What is claimed is:

1. A buoyancy control system for an offshore wind turbine comprising:
a structural steel core;
a syntactic layer configured to be positioned around the structural steel core;
buoyancy material embedded within the syntactic layer, wherein the structural steel core, syntactic layer and buoyancy module form a column having a density that is ten to twenty percent of water.

2. The buoyancy control system of claim 1, wherein the syntactic layer is round or squared in shape.

3. The buoyancy control system of claim 1, further comprising:
a spar hull, wherein the syntactic layer is directly coupled to the spar hull through pontoons and bracings.

4. The buoyancy control system of claim 3, further comprising:
a plurality of columns, wherein the positioning of each of the plurality of columns is based on overturning movement caused by the offshore wind turbine.

5. The buoyancy control system of claim 4, wherein the overturning movement caused by the offshore wind turbine is based on a dominate wind direction.

6. The buoyancy control system of claim 5, wherein the positioning of the
the plurality of columns is configured to reduce inertia radius of gyration.

7. The buoyancy control system of claim 3, wherein the spar hull includes two or more telescoping sections, wherein a first of the telescoping sections is configured to be lowered to extend a draft of the spar hull and move a solid ballast to lower a center of gravity of the buoyancy control system.

8. The buoyancy control system of claim 7, wherein the solid ballast is configured to be retracting during construction, installation, and decommissioning.

9. The buoyancy control system of claim 7, wherein the spar hill is a double hull structure configured to control flood damage.

10. The buoyancy control system of claim 7, further comprising:
a heave plate coupled to a bottom of the spar hull, the heave plate being configured to provide additional vertical hydrodynamic damping and ballast.

11. The buoyancy control system of claim 3, further comprising:
Horizontal beams positioned between adjacent columns below a water surface.

12. The buoyancy control system of claim 3, wherein a diameter of the spar hull is greater than or equal to a turbine tower diameter, the turbine tower being a support for the offshore wind turbine.

13. The buoyancy control system of claim 3, further comprising:
mooring lines connected to the spar hull to reduce mooring line dynamics and a load on the plurality columns.

14. The buoyancy control system of claim 13, wherein the mooring lines are chain braced to adjacent columns to reduce yaw motion of a platform of the offshore wind turbine and to reduce clearance between the mooring lines and the platform.

15. The buoyancy control system of claim 3, further comprising:
syntactic buoyancy modules coupled to the spar hull to provide extra buoyancy and stability during transit and maintenance.

16. The buoyancy control system of claim 1, wherein the syntactic layer includes a plurality of syntactic buoyancy foams that are coupled to the structural steel core and adjacent syntactic buoyancy foams.

17. The buoyancy control system of claim 1, wherein the buoyancy material is formed with large numbers and sizes of light weight spheres, tubes, cubes, or cellular structures that are made of plastic, composite, foam, or voids, which are molded together using epoxy or cementing materials.

18. The buoyancy control system of claim 17, wherein the buoyancy material is configured to withhold hydrostatic pressure and wave load.

19. The buoyancy control system of claim 1, wherein the structural steel cores are stabilized with bracings to transfer a buoyancy force provided by the syntactic layer to support and stabilize the offshore wind turbine.
